(19) United States
(12) Patent Application Publication
(10) Pub. No.: US 2022/0211168 A1
(43) Pub. Date: Jul. 7, 2022

(54) SYSTEMS AND METHODS FOR PROVIDING ADAPTIVE PHYSICAL FEEDBACK TO A USER OF A HAND-HELD DEVICE

(71) Applicant: KONINKLIJKE PHILIPS N.V., EINDHOVEN (NL)

(72) Inventor: Taylor BEVIS, Bothell, WA (US)

(21) Appl. No.: 17/604,470

(22) PCT Filed: Apr. 16, 2020
(86) PCT No.: PCT/EP2020/060641

§ 371 Date: Oct. 18, 2021

Related U.S. Application Data
(60) Provisional application No. 62/835,603, filed on Apr. 18, 2019.

(51) Int. Cl. A46B 15/00; A61C 17/22; G09B 19/00

(52) U.S. Cl. CPC A46B 15/0046; G09B 19/0084; A61C 17/221; A46B 15/0006

(57) ABSTRACT

The present disclosure is directed to systems and methods for providing adaptive physical feedback to a user of an oral care device. Methods for providing adaptive physical indicators to a user of a hand-held device comprise: determining, by a controller and one or more sensors of the hand-held device, a current orientation or position of the hand-held device; determining, by a controller of the hand-held device, a deviation from a target orientation for the hand-held device or a proximity of the hand-held device to target locations; determining, by a controller of the hand-held device, a desired correction of orientation or position; and providing, using a sensory feedback module of the hand-held device, a physical indicator to a user.

### FIELD OF THE INVENTION

The present disclosure is directed to systems and methods for providing adaptive physical feedback to a user of a hand-held device, for example, an oral care device.

### BACKGROUND

Acquiring and maintaining good oral care habits is important to both oral and systemic health. However, despite numerous recommendations from health professionals and dedicated coaching via smart oral care products (e.g., networked or internet connected toothbrushes), complying with an oral care regimen remains a challenge for many consumers. The impact of professional recommendation often fades away in a short period of time after visiting a dental office. Accordingly, there is a continued need in the art for oral care systems and methods that facilitate good oral care habits in users.

### SUMMARY OF THE INVENTION

The present disclosure is directed to inventive systems and methods for providing adaptive physical feedback to a user of a hand-held device. An oral care system may include an oral care device, one or more sensors configured to sense the position and orientation of the oral care device as it is being used, one or more controllers to determine the correction required to the position and orientation of the device, and a sensory feedback module designed to provide a physical indicator to a user to correct the position and orientation of the device.

Generally, in one aspect, a method for providing adaptive physical indicators to a user of a hand-held device is provided. The method includes: (i) determining, by a controller and one or more sensors of the hand-held device, a current orientation of the hand-held device; (ii) determining, by a controller of the hand-held device, a deviation from a target orientation for the hand-held device; (iii) determining, by a controller of hand-held device, a desired correction of orientation; and (iv) providing, using a sensory feedback module of the hand-held device, a physical indicator to a user.

In an aspect, the method allows for the current orientation to be determined using: cameras, inertial motion units, inclinometers, or proximity sensors.

In an aspect, the method allows for the desired correction to be made to allow for feedback smoothing.

In an aspect, the method allows for the physical indicator to have variable timing or magnitude.

In an aspect, the method allows for the physical indicator to be applied via a proportional-integral-derivation scheme.

Generally, in one aspect, a method for providing adaptive physical indicators to a user of a hand-held device is provided. The method includes: (i) determining, by a controller and one or more sensors of the hand-held device, a current position of the hand-held device; (ii) determining, by a controller of the hand-held device, a desired correction of position; and (iii) providing, using a sensory feedback module of the hand-held care device, a physical indicator to a user.

In an aspect, the method further involves the step of determining, by a controller of the hand-held device, a proximity of the hand-held device to a target location.

In an aspect, the method allows for the current position to be determined using: cameras, inertial motion units, inclinometers, or proximity sensors.

In an aspect, the method allows for the desired correction to be made to allow for feedback smoothing.

In an aspect, the method allows for the physical indicator to have variable timing or magnitude.

In an aspect, the method allows for the physical indicator to be applied via a proportional-integral-derivation scheme.

Generally, in one aspect, an oral care system for providing adaptive physical indicators to a user of an oral care device is provided. The oral care system includes: an oral care device; a sensor module configured to detect the location and angle of a brush head of the oral care device in a user's mouth; a memory module configured to store brushing location related data; a sensory feedback module of the oral care device configured to provide a physical indicator; and one or more controllers. The one or more controllers are configured to: determine a current orientation or position of the oral care device; determine a deviation from a target orientation for the oral care device or determine a proximity of the oral care device to a target location; and determine a desired correction of orientation or position and provide a physical indicator using the sensory feedback module.

In an aspect, the system is further configured such that the sensory feedback module relies on inertial steering to provide the physical feedback.

In an aspect, the system is further configured such that the inertial steering is provided by one or more control moment gyroscopes.

In an aspect, the system is further configured such that the sensory feedback module relies on one or more off-center-of-gravity masses to provide the physical feedback.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic representation of an oral care device in accordance with an exemplary embodiment.

FIG. 2A and FIG. 2B are drawings of off-center-of-gravity masses in accordance with an exemplary embodiment.

FIG. 3 is a drawing of multiple off-center-of-gravity masses in a sensory feedback module in accordance with an exemplary embodiment.

FIG. 4 is a flowchart of a method for providing adaptive physical indicators to a user of an oral care device in accordance with an exemplary embodiment.

FIG. 5 is a flowchart of a method for providing adaptive physical indicators to a user of an oral care device in accordance with an exemplary embodiment.

### DETAILED DESCRIPTION OF EMBODIMENTS

The present disclosure is directed to systems and methods for providing adaptive physical feedback to a user of a hand-held device. The system includes: a hand-held device; a sensor module configured to detect the location and angle of the hand-held device while it is being used; a memory module configured to store data related to the area of use of the hand-held device; a sensory feedback module of the hand-held device configured to provide a physical indicator; and one or more controllers. The one or more controllers are configured to: determine a current orientation or position of the hand-held device; determine a deviation from a target orientation for the hand-held device or determine the proximity of the hand-held device to a target location; determine a desired correction of orientation or position; and provide a physical indicator using the sensory feedback module.

The physical indicator is designed to provide a physical shift in the hand-held device to which a user reacts by changing the orientation or position of the hand-held device in accordance with the desired correction. The physical shift can be provided by off-center-of-gravity masses where moving masses shift the center of gravity of the device to create an off balance feeling for the user. The user then changes the position or orientation or angle of the device to adjust and/or correct the unbalanced sensation. The physical shift can also be in the form of an inertial steering, where a force pulls the device in a particular direction. The force can come from inertial steering devices such as control moment gyroscopes. The pulling force can either move the device in accordance with the desired correction or the pulling force can serve as an indicator to the user to move the device along the direction of the force.

The embodiments and implementations disclosed or otherwise envisioned herein can be utilized with any suitable hand-held or personal care device. Examples of suitable hand-held or personal care devices include a toothbrush, such as a Philips Sonicare® toothbrush (manufactured by Koninklijke Philips, N.V.), a shaver, a flossing device, an oral irrigator, an interdental cleaning device, a tongue cleaner, a skin care device, or other personal care device. However, the disclosure is not limited to these personal care devices, and thus the disclosure and embodiments disclosed herein can encompass any handheld or personal care device. Although examples of oral care devices are described herein, one of ordinary skill in the art will recognize that the system and methods can be utilized in connection with a wide variety of hand-held or personal care devices.

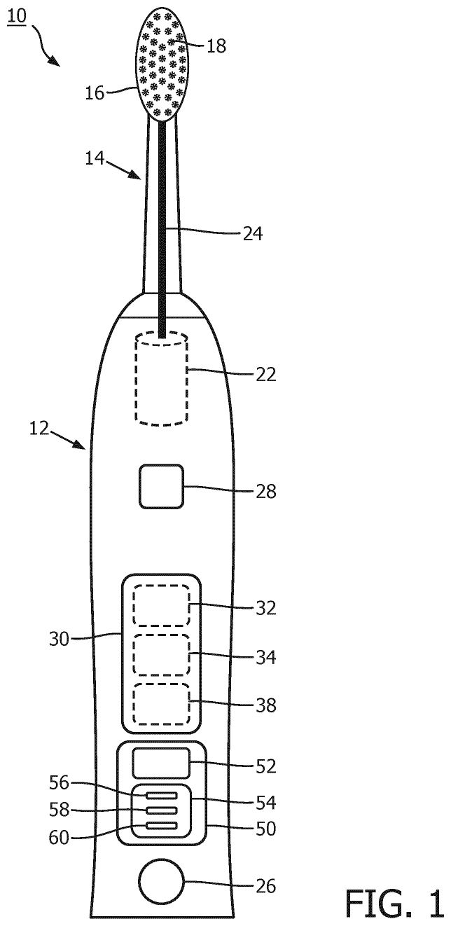

Referring to FIG. 1, in one embodiment, a powered oral care device 10 is provided that includes a handle or body portion 12 and a brush head member 14. Brush head member 14 includes at its end remote from the body portion a brush head 16. Brush head 16 includes a bristle face 18, which provides a plurality of bristles. The body portion 12 typically includes a housing, at least a portion of which is hollow, to contain components of the powered oral care device. The body portion 12 can include a drivetrain assembly with a motor 22 for generating movement, and a transmission component or drivetrain shaft 24, for transmitting the generated movements to brush head member 14.

According to one embodiment, brush head member 14 is mounted to the drivetrain shaft 24 so as to be able to move relative to body portion 12. The movement can be any of a variety of different movements, including vibrations or rotation, among others. For example, the brush head member 14 can be fixedly mounted onto drivetrain shaft 24, or it may alternatively be detachably mounted so that brush head member 14 can be replaced with a different brush head member for different operating features, or when the bristles or another component of the brush head are worn out and require replacement. Although in the present embodiment the powered oral care device 10 is an oscillating toothbrush, it will be understood that in alternative embodiments the powered oral care device can be any other powered personal care device.

Body portion 12 is further provided with a user input 26 to allow a user to operate the powered oral care device 10, for example, to turn the device on and off. The user input 26 may, for example, be a button, touch screen, or switch.

Powered oral care device 10 includes one or more sensors 28 configured to obtain sensor data indicative of changes in position and orientation or angle during use of the device 10. Sensor 28 is shown in FIG. 1 within body portion 12, but may be located anywhere within or on the exterior of the device, including, for example, within or on the exterior of the brush head member 14, brush head 16, or elsewhere within or on the device. According to an embodiment, sensor 28 can include one or more motion sensors, optical sensors, infrared, ultrasonic or optical proximity sensors, timers, cameras, pressure sensors, inclinometers, inertial motion units, magnetometers, gyroscopes, accelerometers, and/or any sensing technology, protocol, type, or modality utilized to collect data related to the position or orientation of a powered oral care device 10.

The device 10 further includes a controller 30 configured to receive sensor data generated by sensor 28. According to one embodiment, sensor 28 is integral to controller 30. Controller 30 may be formed of one or multiple modules, and is configured to operate the oral care device 10 in response to an input, such as input obtained via user input 26. Controller 30 can include, for example, a processor 32 and a memory or database 34. Processor 32 may take any suitable form, including but not limited to a microcontroller, multiple microcontrollers, circuitry, a single processor, or plural processors. Memory or database 34 can take any suitable form, including a non-volatile memory and/or RAM. The non-volatile memory may include read only memory (ROM), a hard disk drive (HDD), or a solid state drive (SSD). The memory can store, among other things, an operating system. The RAM is used by the processor for the temporary storage of data. According to an embodiment, an operating system may contain code which, when executed by controller 30, controls operation of the hardware components of oral care device 10. According to an embodiment, connectivity module 38 transmits collected sensor data, and can be any module, device, or means capable of transmitting a wired or wireless signal, including but not limited to a Wi-Fi, Bluetooth, near field communication, and/or cellular module.

The device further includes a sensory feedback module 50. The sensory feedback module 50 contains one or more physical indicator devices 52, a controller 54 configured to operate a physical indicator, including turn on or off a physical indicator, increase or decrease the magnitude of the physical indicator, receive and process sensor data relating to the physical indictor, determine the current position of the oral care device and the current orientation or angle of the oral care device, determine a deviation from a target orientation for the oral care device; determine a proximity of the oral care device to a target location; and determine a desired correction of orientation and/or position. Controller 54 can include, for example, a processor 56 and a memory or database 58. Processor 56 may take any suitable form, including but not limited to a microcontroller, multiple microcontrollers, circuitry, a single processor, or plural processors. Memory or database 34 can take any suitable form, including a non-volatile memory and/or RAM. The non-volatile memory may include read only memory (ROM), a hard disk drive (HDD), or a solid state drive (SSD). The memory can store, among other things, an operating system. The RAM is used by the processor for the temporary storage of data. According to an embodiment, an operating system may contain code which, when executed by controller 54, controls operation of the hardware components of the sensory feedback module or oral care device 10. The controller may also contain code for algorithms to learn the appropriate timing, direction, and magnitude of a physical indicator. According to an embodiment, connectivity module 60 sends and/or receives collected sensor data, and can be any module, device, or means capable of transmitting a wired or wireless signal, including but not limited to a Wi-Fi, Bluetooth, near field communication, and/or cellular module. Controller 54 of the sensory feedback module 50 may also work in conjunction with controller 30, processor 32, memory 34, and connectivity module 38, to perform any of its functions. Controller 54 may also work in conjunction with one or more remote devices which include their own controllers or computing resources that are utilized with computing resources from oral care device 10, and which together comprise the controller 54. The remote device may be any computing device capable of data communication (e.g. via connectivity module 38) with one or more components of the oral care device 10. For example, the remote device may be, or include, a computer, a laptop, a tablet, a smartphone, a mobile computing device, a server, a gateway, a network node, internet- or cloud-implemented computing resources, etc.

The physical indicator devices 52 may be any combination of devices which provide sensory feedback in the form of physical movement of the device 10 or displacement of the center of gravity of the device 10. The physical indicator device 52 may be an inertial steering device which provides sensory feedback in the form of physical movement of the device in the direction of the desired movement of the device. The physical movement may be of the magnitude to move the device along the direction of the desired movement or of the magnitude to provide a physical pulling force to the user which encourages the user to move the device along the direction of the force and desired movement. For example, the inertial steering device may contain a control moment gyroscope (“CMG”). An exemplary CMG may contain a spinning rotor and one or more motorized gimbals that tilt the angular moment of the rotor, which causes a gyroscopic torque. The magnitude of the torque created by the CMG is related to the geometry and mass of the CMG and change in its rotational speed. The physical indicator device may be one or more single or multi-axis CMGs. For example, a single-axis CMG in the physical indicator device 52 may be sufficient to provide feedback along the axis of brushing during brushing to correct or influence a user's behavior (for example, brushing along the chewing surface of his/her teeth far enough to reach molars). Multiple CMGs or a multi-axis CMG can provide sensory feedback along multiple axes, for example, to correct the angle of brushing and the direction of brush movement during brushing. With this method of sensory feedback, the user of the oral care device 10 will feel a pull in the desired direction, which may move the oral care device 10 or provide a nudge in the direction of desired motion which signals to the user to move the oral care device 10 along in that direction. It can be appreciated that many other methods of generating relative torques between a rotating object in the sensory feedback module 50 and the user's hand can be devised. The inertial steering can be provided by any physical means to apply an axial or rotational force, including application of a magnetic force, use of high velocity air, or any other methods known in the art. Using inertial steering, a force is provided in the direction of the desired motion, which may move the brush or provide a gentle push or nudge in the direction of desired motion which indicates to the user to move the brush in the desired direction.

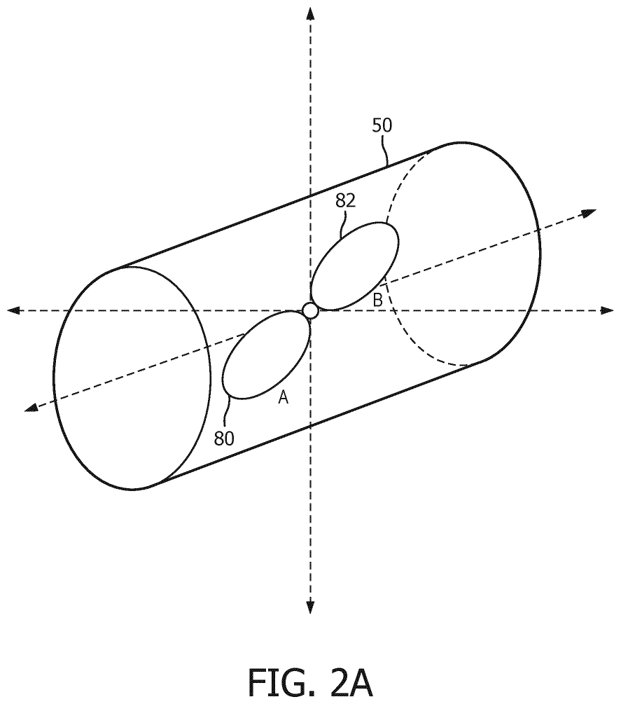

The physical indicator device 52 may rely on off-center-of-gravity masses to provide sensory feedback and the physical indicator. This method of providing sensory feedback causes the user to react to a feeling that the oral care device 10 is not balanced and causes the user to move the oral care device 10 to the desired position or orientation to correct the feeling that the device is not balanced. For example, an improper orientation or angle between a bush head and the user's teeth may be corrected using off-center-of-gravity masses. As shown in FIG. 2A, in a neutral position, positions A and B, the center of gravity of mass 80 and mass 82 is aligned with the physical center of the sensory feedback module 50. To shift the center of gravity, one or both masses 80, 82 are rotated to a prescribed position A′, B′. As shown in FIG. 2B, when mass 80 and mass 82 are shifted to new positions A′, B′, more mass is shifted to L side of the sensory feedback module 50. The user can feel that the center of gravity of the device is off balance. The user's reaction to the now off balance center of gravity is to rotate the handle in the D2 direction to align the center of gravity properly, so that the masses are aligned with the earth. The shift in center of gravity may be provided by different forms of movable masses, including two rotating blades with mass 80,82, a plurality of rotating blades with mass (which would allow for an increase in magnitude of the shift in center of gravity), a fluid pump, moveable masses in compartments where the masses can move between compartments, a linear slide where masses can move along an axis of the linear slide, or any other means to manipulate the location of masses.

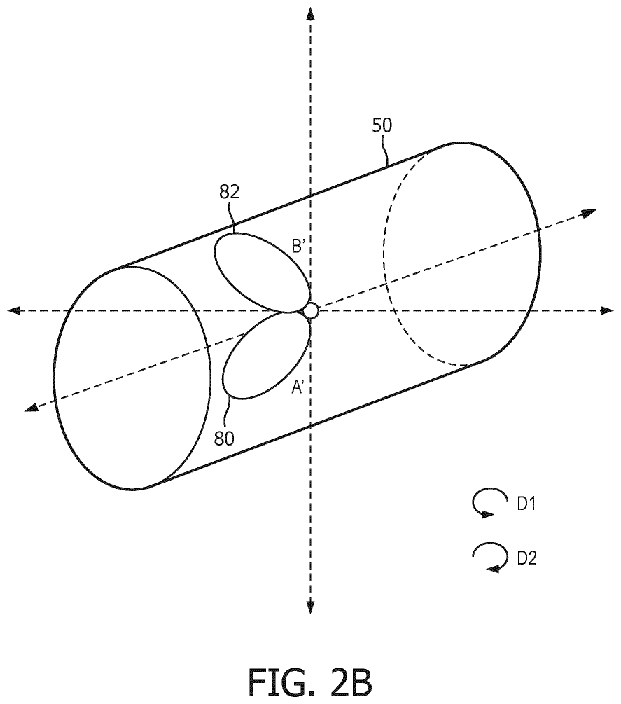

The physical indicator device 52 may rely on one or more off-center-of-gravity masses to provide the physical indicator. When multiple off-center-of-gravity masses are used, physical feedback in both a rotational direction and a longitudinal direction may be provided. FIG. 3 shows two blades with mass 80, 82 which are unbalanced with respect to the center C of the sensory feedback module 50. In response to a feeling that the center of gravity of the device is off balance, a user will rotate the oral care device 10 in rotational direction D2. Three additional masses, 84, 86, and 88, can also move in the sensory feedback module 50 along axis 90. The movement of masses 84, 86, and 88 can be in the f and b directions, which are longitudinal directions along an axis through the center of the oral care device 10 from the base to the head. If the masses 84, 86, and 88 are moved in the b direction, a shift in the center of gravity of the sensory feedback module 50 will cause the user to move the oral care device 10 in the f direction. In this way, a user can correct the orientation angle (in the rotational direction) of the oral care device 10 and the position (along the longitudinal axis in the f and b direction) of the oral care device 10.

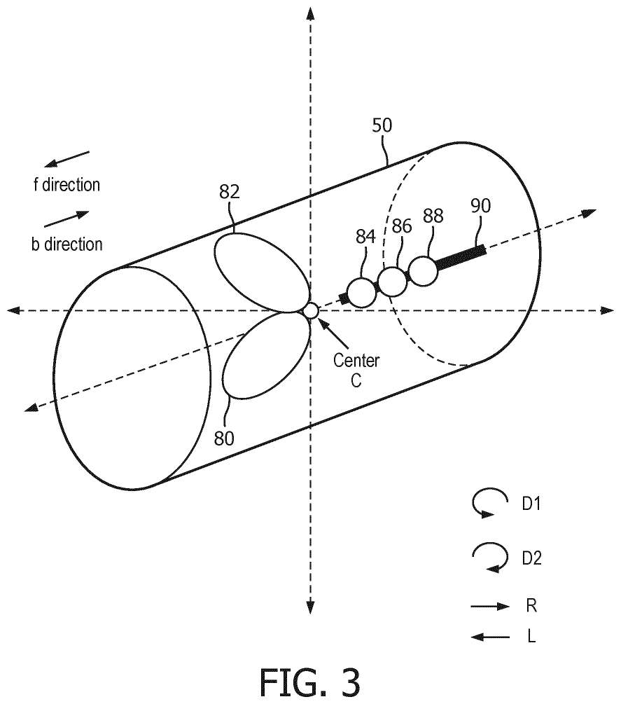

FIG. 4 shows an exemplary method 200 for providing adaptive physical indicators to a user of an oral care device. At step 210, a current orientation of the oral care device 10 is determined using the controller 54 and sensors 28 of the oral care device 10. For example, an angle or orientation of the brush head 16 with respect to the teeth of a user can be determined using motion sensors, optical sensors, infrared, ultrasonic or optical proximity sensors, timers, cameras, pressure sensors, inclinometers, inertial motion units, magnetometers, gyroscopes, or accelerometers, where the orientation of the brush head 16 is compared to the orientation of the user's head and teeth. The controller 54 may fuse data from combinations of different sensors 28 to make more accurate or higher level determinations. Data collected from sensors 28 can be analyzed by algorithms to enhance the sensory feedback and physical indicators that are provided during brushing. At step 220, the controller 54 is used to determine the deviation from a target orientation of the oral care device 10. For example, a target orientation of an oral care device 10 which is a toothbrush may be that the toothbrush is oriented at a 45 degree angle with respect to the surface of a user's teeth. If the user's brush is positioned so that it is at a 27 degree angle with respect to his/her teeth, the deviation from target orientation would be 18 degrees. At step 230, the controller determines a desired correction of orientation. For example, the controller may determine that the toothbrush should be rotated an additional 18 degrees to correct the orientation of the toothbrush to be at a 45 degree angle with respect to the user's teeth. However, the controller may determine that a different deviation in orientation does not require a correction of orientation. Feedback smoothing is any process which reduces the amount of sensory feedback received by the user so as to eliminate excessive sensory feedback. For example, one form of feedback smoothing is to provide no correction of orientation for small deviations. As an example, a deviation of five degrees or less from a target orientation may not warrant a correction of orientation. Deviations that are not sufficiently large may not warrant correction so that the system does not provide excessive sensory feedback for minor deviations. Excessive sensory feedback may cause annoyance to the user or disrupt use of the device with frequent sensory feedback from frequent minor deviations in orientation.

At step 240, a physical indicator is provided using the sensory feedback module 50 to a user of the oral care device 10. The operation of the sensory feedback module 50 is controlled by the controller 54. The physical indicator is provided by one or more physical indicator devices 52, which may be any combination of devices that provide sensory feedback in the form of physical movement of the device 10 or displacement of the center of gravity of the device 10, using inertial steering and off-center-of-gravity mass methods, respectively, to provide sensory feedback.

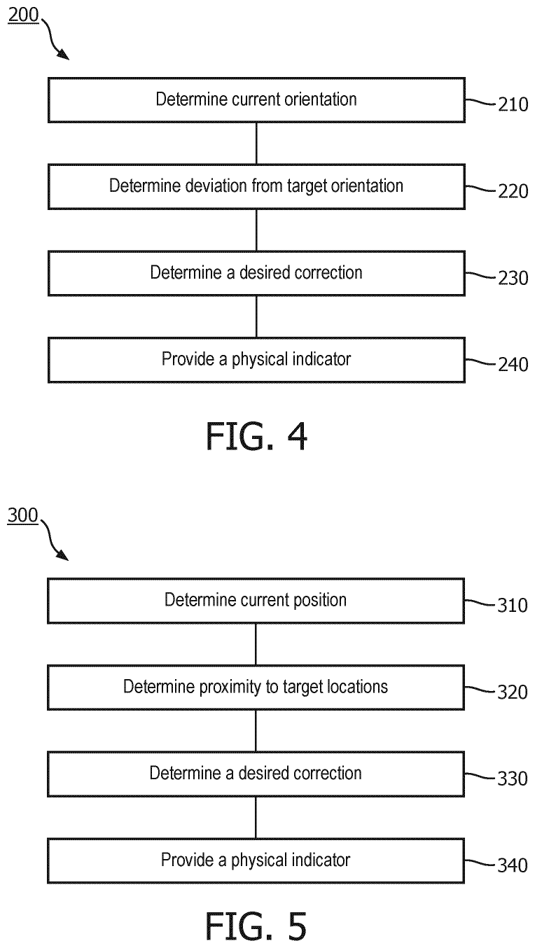

FIG. 5 shows an exemplary method 300 for providing adaptive physical indicators to a user of an oral care device 10. At step 310, a current position of the personal care device is determined using the controller 54 and sensors 28 of the oral care device 10. For example, the position of a brush head 16 of a toothbrush with respect to a user's mouth can be determined using sensors 28, such as motion sensors, optical sensors, infrared, ultrasonic or optical proximity sensors, timers, cameras, pressure sensors, inclinometers, inertial motion units, magnetometers, gyroscopes, or accelerometers. As an example, the areas of the teeth that have been brushed are determined at least in part from the relative position of the oral care device 10 with respect to the user, which can be ascertained by using a movement sensor, such as an embedded inertial measurement unit, to determine an absolute position of the oral care device 10, and an optical or proximity sensor, such as an infrared proximity sensor or a camera, to account for relative motion of the user's head with respect to the oral care device 10. The controller 54 may fuse data from combinations of different sensors 28 to make more accurate or higher level determinations. Data collected from sensors 28 can be analyzed by algorithms to enhance the sensory feedback that is provided during brushing.

At optional step 320, the controller 54 is used to determine proximity of the oral care device to a target location. Target locations or areas of the teeth which have been recently missed during brushing, which are frequently missed by the user or by others, or areas which are brushed for too short a duration are under other sub-optimal conditions. The target locations may be learned for a particular user, they may be pre-programmed into the device and not specific to a user, or they may be a combination of previously programmed and learned locations. The controller 54 may rely on a map of a user's mouth and teeth to determine where along the map the brush is currently positioned and the user's proximity to target locations. The oral care device 10 may rely on a teeth map which has been previously programmed into the controller module 30 or sensory feedback module 50 or on a map which was learned or programmed individually for the user. For example, a user may be instructed to initially trace his/her teeth with the brush head 16. The user may be guided (e.g., instructed via printed instructions, an application installed on a smartphone, etc.), to move the brush head 16 against particular teeth without the motor running and/or to follow a particular path or routine during one or more brushing sessions.

At step 330, the controller 54 determines a desired correction of position. For example, the controller 54 may determine that a correction of position is desired when a user is in proximity to an area of the mouth or teeth which is frequently missed during brushing. Using machine learning, the controller 54 can be more effective overtime as it learns what areas of the mouth or teeth are missed more frequently. If the brush head 16 is in proximity to a less frequently missed area of the mouth or teeth, the controller 54 may determine that no correction of position is desired. Feedback smoothing is any process which reduces the amount of sensory feedback received by the user so as to eliminate excessive sensory feedback. When an area of the mouth or teeth is missed less frequently during brushing, a correction of position may not be desirable so that the system does not provide excessive sensory feedback for minor deviations. Excessive sensory feedback may result in annoyance to the user or obstruct the use of the device with frequent sensory feedback from frequent minor deviations in position.

At step 340, a physical indicator is provided using the sensory feedback module 50 to a user of the oral care device 10. The physical indicator is provided by one or more physical indicator devices 52 which may be any combination of devices which provide sensory feedback in the form of physical movement of the device 10 or displacement of the center of gravity of the device 10, using inertial steering and off-center-of-gravity mass methods, respectively, to provide sensory feedback.

The timing or magnitude of the physical indicator and the sensory feedback can be made to vary. The magnitude and duration of the physical indicator can be larger or smaller in response to different desired corrections of orientation or position. For example, a greater off-center-of-gravity mass can be used for a greater correction of angle or orientation of the brush. For areas of the mouth or teeth that are more frequently missed, the inertial steering physical indicator can provide a pull that is of a larger magnitude. As another example, the timing of the physical indicators can increase when a greater correction is desired. For example, multiple successive physical indicators may indicate that a greater correction is desired. As another example, the physical indicator may last for a longer duration, which indicates that a greater correction in position (e.g., a large area of the mouth or teeth was missed in the past or that an area of the mouth or teeth has been frequently missed in the past) is required. In another example, successive physical indicators may be provided (for example, in the form of a pull) where the successive physical indicators increase in magnitude (the force of the pull), as a means to encourage the user to move the brush along to cover the desired position. As another example, the physical indicator can be in the form of an off-center-of-gravity mass when a user has deviated from the correct orientation (for example, the user is brushing with an angle which is not desirable). The physical indicator can be provided in the form of off-center-of-gravity masses where the magnitude of the off-center-of-gravity masses decreases as the user corrects his orientation and moves his brush closer and closer to the correct orientation. This is an example of an application of a proportional-integral-derivation scheme for the physical indicator.

An algorithm can be used to determine the timing, direction, and magnitude of the physical indicator that is required to provide the desired result, correction of the orientation or the position of the oral care device 10. The sensory feedback which a user receives in response to a deviation from the desired orientation or position of the oral care device 10 must be appropriate enough to result in the user correcting his/her orientation or position in the desired direction and in the desired amount. The sensory feedback module 50 can be programed to learn the appropriate direction and magnitude of the physical indicator which will produce the desired response in a user. As another example, the sensory feedback module 50 may be set to determine the current orientation or position of the oral care device 10 and the desired correction of orientation or position, and then provide a physical indicator, at set intervals of time. The timing of the physical indicator, or the timing of the adaptive physical indicator loop (determining a current position or orientation, determining a deviation in orientation or a proximity to a target location, determining a desired correction, providing a physical indicator), can be set to be frequent enough to ascertain when the user has deviated from the desired orientation or position, but not too frequent, in order to allow time for the user to correct the orientation and/or position of the oral care device 10. The timing, direction, and magnitude of the physical indicator can be preset before a user uses the oral care device 10, or an algorithm may be used to learn the appropriate timing, direction, and magnitude of the physical indicator for each user, or a combination of both techniques may be used.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. As used herein in the specification and in the claims, “or” should be understood to have the same meaning as “and/or” as defined above.

It should also be understood that, unless clearly indicated to the contrary, in any methods claimed herein that include more than one step or act, the order of the steps or acts of the method is not necessarily limited to the order in which the steps or acts of the method are recited.

1. A method for providing adaptive physical indicators to a user of a personal care device, comprising:
determining, by a controller and one or more sensors, of the personal care device, a current orientation or position of the personal care device;
determining, by a controller of the personal care device, a deviation from a target orientation for the personal care device or a proximity of the personal care device to a target location;
determining, by a controller of the personal care device, a desired correction of orientation or position; and
providing, using a sensory feedback module of the personal care device, a physical indicator to a user, wherein the physical indicator provides a physical shift in the personal care device representative of the desired correction.

2. The method of claim 1, wherein the current orientation or position is determined using: cameras, inertial motion units, inclinometers, or proximity sensors.

3. The method of claim 1, wherein the desired correction is made to allow for feedback smoothing.

4. The method of claim 1, wherein the physical indicator has variable timing.

5. The method of claim 1, wherein the physical indicator is applied via a proportional-integral-derivation scheme.

6. (canceled)

7. (canceled)

8. (canceled)

9. (canceled)

10. (canceled)

11. (canceled)

12. An oral care system for providing adaptive physical indicators to a user of an oral care device, comprising:
an oral care device;
a sensor module configured to detect the location and angle of a brush head of the oral care device in a user's mouth;
a memory module configured to store brushing location related data;
a sensory feedback module of the oral care device configured to provide a physical indicator; and
a controller for providing adaptive physical indicators to a user of a personal care device configured to:
determine a deviation from a target orientation for the personal care device or a proximity of the personal care device to a target location;
determine a desired correction of orientation or position; and
provide a physical indicator using a sensory feedback module, wherein the physical indicator provides a physical shift in the personal care device representative of the desired correction.

13. The system of claim 12, wherein the sensory feedback module relies on inertial steering to provide the physical feedback.

14. The system of claim 13, wherein the inertial steering is provided by one or more control moment gyroscopes.

15. The system of claim 12, wherein the sensory feedback module relies on one or more off-center-of-gravity masses to provide the physical feedback.

16. A controller for providing adaptive physical indicators to a user of a personal care device, configured to:
determine, using one or more sensors, a current orientation or position of the personal care device;
determine a deviation from a target orientation for the personal care device or a proximity of the personal care device to a target location;
determine a desired correction of orientation or position; and
provide a physical indicator using a sensory feedback module, wherein the physical indicator provides a physical shift in the personal care device representative of the desired correction.

17. The method of claim 1, wherein the physical indicator has variable magnitude.
